(19) United States
(12) Patent Application Publication
(10) Pub. No.: US 2009/0255165 A1
(43) Pub. Date: Oct. 15, 2009

(54) Fishing line stop

(76) Inventor: James A. Myers, McKinney, TX (US)

Correspondence Address: James A. Myers, 2832 Rush Creek Rd., McKinney, TX, 70070, US

(21) Appl. No.: 12/381,674

(22) Filed: Mar. 14, 2009

Related U.S. Application Data
(60) Provisional application No. 61/069,478, filed on Mar. 15, 2008.

(51) Int. Cl. A01K 91/04; A01K 93/00

(52) U.S. Cl. 43/4.5; 43/44.91

(57) ABSTRACT

What is disclosed is a fishing line stop for use with a method know in the art as slip bobber fishing. A main body shaped like a cone oval, round or cylindrical shaped is slid able along a fishing line, placed on a fishing line and above a fishing bobber or lure. A second part of the fishing line stop in the form of a prettied knot, string or rubber band encircles the main body completing a fishing line stop assembly. A fishing line from a fishing pole is inserted into and through the main body and the knot is release from the main body and onto the fishing line toward the fishing pole. The knot is secured firmly on the fishing line to determined the fishing depth. The main body of the fishing line stop assembly slides freely along the fishing line and is located above the bobber or lure and below the secured knot on the fishing line.

### CROSS REFERENCE TO RELATED APPLICATIONS

This application claims the benefit of U.S. Provisional Application Nos. 61/069,478 filed on Mar. 15, 2008 entitled “Fishing Line Stop”.

### TECHNICAL FIELD

The present invention relates to fishing terminal tackle, bobbers, lines, poles, lures and rigs.

### BACKGROUND OF THE INVENTION

A variety of related apparatus are well known in the art. For example, in U.S. Pat. No. 7,434,349, a prettied knot is supplied on a disposable tube. The fishing line is passed through the tube and the tube is discarded. In United States publication 20080282599 a bead attachment is shown, in which a fishing line is clamped and secured between a hinged body. U.S. Pat. No. 3,911,610 in which a fishing line is threaded through a series of holes in a plastic strip. U.S. Pat. No. 5,203,107 has a body with a notch in which the fishing line is fed and clamped. U.S. Pat. No. 3,196,575 uses a coil and a bead as a stopping means. U.S. Pat. No. 4,571,874 utilizes a fishing line through a tube as a stopping mechanism. A commonly known bobber stop is a knot, string or rubber band tied onto the fishing line and used in combination with a bead. Prettied knots supplied on a disposable tube and beads are common and readily available in the marketplace.

### SUMMARY OF THE INVENTION

The present invention allows the fisherman to apply a bobber stop for setting fishing depth with the use of a fishing bobber. It further allows a buoyant and highly visible bobber stop body. The present invention advantageously combines a body and prettied knot into one convenient stop assembly, thus eliminating the need for a disposable plastic tube such as known prior apparatus.

To those skilled in the art to which this invention relates, many changes in construction and widely differing embodiments and applications of the invention will suggest themselves without departing from the scope of the invention as defined in the appended claims. The disclosures and description herein are purely illustrative and are not intended to be in any sense limiting.

### DETAILED DESCRIPTION OF THE A PREFERRED EMBODIMENT

A fishing line stop for a fishing line. The disclosed stop is used with a fishing style well known in the art as slip bobber fishing. When slip bobber fishing, a fishing line passes freely back and forth through a fishing device. This method of fishing is most commonly used with a fishing bobber or float. A limiting device is placed on a fishing line above a bobber or float. The stop device, referred to as a fishing line stop is clamped or slide able along the fishing line. This allows the fisherman to choose a desired fishing depth. When the bobber or float is cast upon the water, a fishing rig and bait drops into the water to a depth which is determined by the placement of the line stop. The fishing line stop is of a size such that it cannot passes through a small opening on top of a bobber or float. The bobber stop will rest on top of the bobber when the desired depth is achieved. When this type of fishing known as slip bobber fishing is utilized, fisherman can perform what is known as jigging or bouncing the bait up and down in the water to attract fish.

There are many known bobber stops in the art of fishing. These include a prettied knot in the form of string, yarn, fishing line, beads, weights and plastic strips among others. These devices are sometimes used independently or in a combination. Oftentimes, a partially prettied knot is used in combination with a bead. A knot is place on the fishing line to set the desired fishing depth. This knot is not passable through a bore placed through the center of a bead. In turn, the bead is of such a size that it cannot be passed into an opening in the top of a fishing bobber. With this combination, the bead is usually freely slide able along the fishing line and the knot is firmly secured to the fishing line. One commonly known knot of this type is a partially prettied knot wrapped around a small, disposable plastic tube. To apply the knot to the fishing line, the line is passed through the tube. The prettied knot is then slide able off of the tube and onto the fishing line. The plastic tube is then discarded, oftentimes in the waterway or on the ground. Two ends of the knot are then pulled tightly around the fishing line. The tightly secured knot can then slide upon the line to the desired fishing depth.

Oftentimes, bobber stops have disadvantages which reduces the performance of slip bobber fishing. Small beads and stops often travel through the eyelets of a fishing pole and interfere with the smooth casting of the fishing line. These beads and other small bobber stop types often get wound into the reel of the fishing pole causing inefficient casting of the fishing line and binding of the fishing pole reel. Larger beads which will not pass into the smallest, end eyelet of the fishing pole are often used to eliminate the bead from interfering with the cast. The larger bead is also sized as such to not pass through a device such as a fishing bobber when the desired fishing depth is obtained. When the desired fishing depth is reached, the bobber stop, bead or knot sets on the top of the fishing bobber, stopping a bait and rig to the desired fishing depth. Furthermore, the smaller knot or stop is allowed to pass along the fishing pole and into the reel of the fishing pole, while the larger bead will stop at the end of the fishing pole. These bobber stop beads, knots, weights and other types are oftentimes not buoyant and drag through the water. This inhibits the travel of the bobber stop to the top of the bobber when in the water. When casting a fishing bait, rig and bobber at some distance, it is desired that the weight of the fishing bait and rig to drop into the water and pull the bobber stop to the top of the bobber. This action is inhibited when lighter fishing rigs are used. Bobber stops are often not buoyant which causes interference with the efficient casting and the passing of a fishing line through a bobber. The fishing line is also pulled under the water by bobber stops which further inhibits the desired action of the bobber stop reaching the top of the bobber in a timely manner.

The disclosed bobber stop has many features which over come these issues and has many other advantageous features. The disclosed bobber stop comprises being made of a buoyant material such as plastic, wood or ant buoyant material. The body contains a hole or bore through it's center. The bobber stop is formed into, but not limited to, a substantially cone, bugle or oval shape. The body is sized as such that is cannot pass into the smallest eyelet at the end of a fishing pole. In one preferred shape of the bobber stop body, the small end of the stop is such that it is optionally inserted into a fishing bobber. A small hole, bore or opening is located in the smaller end of the bobber stop. The hole, bore or opening in the smaller end is large enough to allow a fishing line to pass freely through and small enough to not allow a string knot or other small fixed stop to be passed through the body. A second end of the bobber stop is body is tapered, rounded or pointed in shape. A prettied knot is affixed to the body in such a way to encircle the body. The prettied knot is released onto the fishing line from the bobber stop body after the fishing line is inserted through the body. The prettied knot is released from the, body and firmly attached to the fishing line. The knot remains attached firmly above the fishing bobber and body of the bobber stop assembly and slid by hand to set the fishing depth.

The main advantage of the disclosed bobber is stop is that is supplied with a prettied knot encircling the bobber stop body stop. These prettied knots are known in the art and are supplied via a small plastic tube. These knots are often supplied with the combination of a bead or other slid able stop member. The disposable tube is often discarded into the water or surrounding ground and contributes to the harming of the environment. The disclosed bobber stop eliminates the discarding of the plastic tube by supplying the knot onto the bobber stop body. The disclosed bobber stop can also used with lures such as plastic or rubber worms and other artificial or live baits for determining fishing depth without the use of a bobber.

FIG. 1 shows a perspective a preferred embodiment of the bobber stop with the body (1a) with the prettied knot (1b) encircling the body.

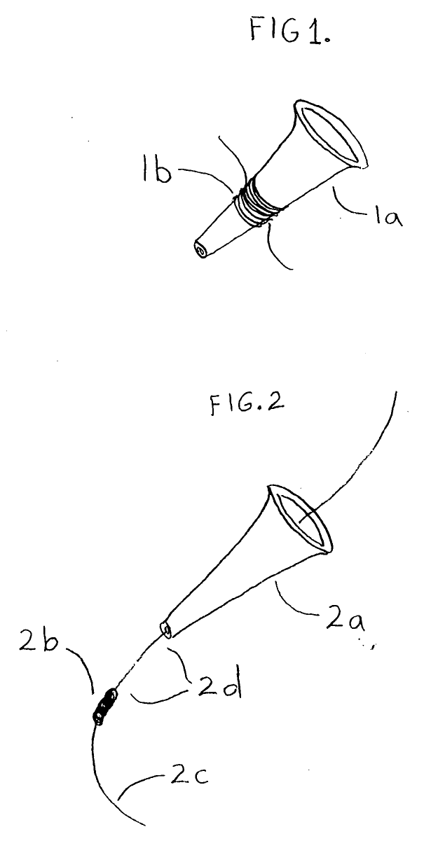

FIG. 2 shows a perspective of a preferred embodiment of the bobber stop with the body (2a), the prettied knot (2b) released onto the fishing line (2c) at the predetermined fishing depth (2d).

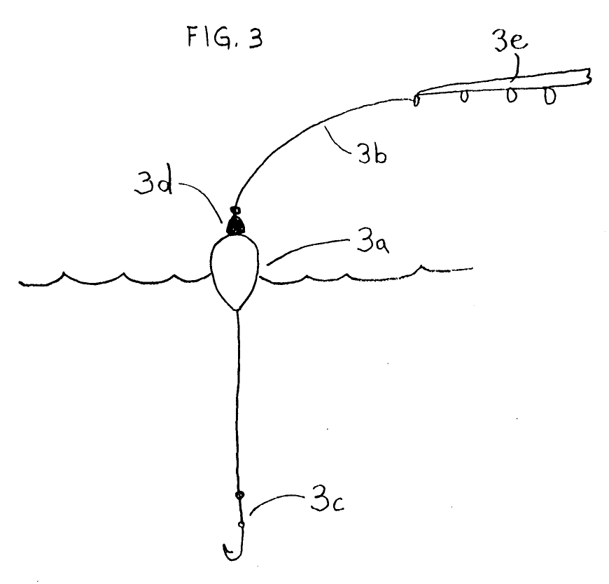

FIG. 3 shows a side view of the present invention in the water in use with a bobber (3a), fishing line (3b), fishing rig at the desired depth (3c), the bobber stop (3d) in the fishing position and a fishing pole (3e).

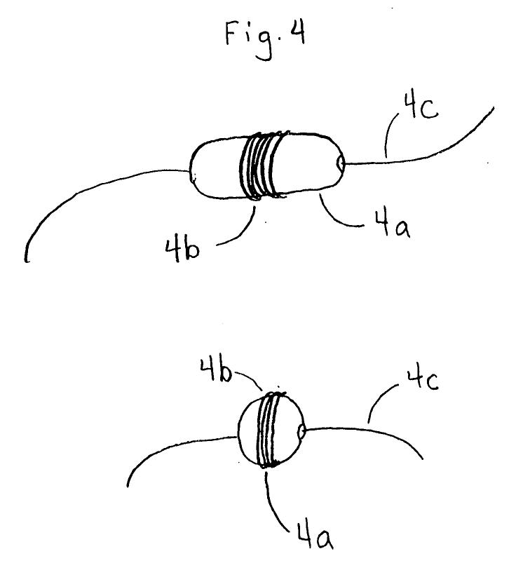

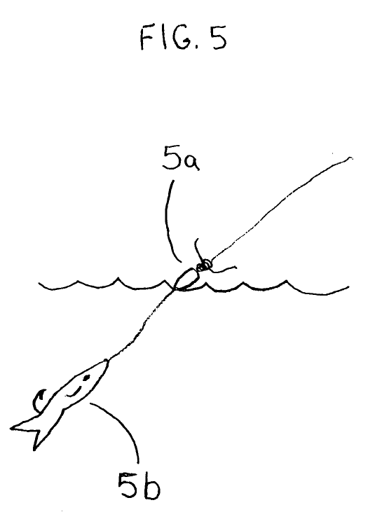

FIG. 4 shows a side views of two additional preferred embodiments of the bobber stop body (4a) knot (4b), fishing line (4c).

FIG. 5 shows the bobber stop assembly (5a) in use with a fishing lure (5b).

I claim:

1. A fishing line stop comprising; a main body, an opening through said main body for the admission of a fishing line to pass therethrough; a knot encircling said main body; said knot releasable off of the said main body and firmly tightened onto the said fishing line.

2. The fishing line stop claim 1, wherein said main body further comprises being made of a buoyant material.

3. The fishing line stop of claim 1, wherein said main body further comprises being made of plastic.

4. The fishing line stop of claim 1, wherein said main body further comprises being substantially cone shaped.

5. The fishing line stop of claim 1, wherein said main body further comprises being substantially oval shaped.

6. The fishing line stop of claim 1, wherein said main body further comprises being substantially round shaped.

7. The fishing line stop of claim 1, wherein said knot further comprises a prettied knot.

8. The fishing line stop of claim 1, wherein said knot further comprises a string.

9. The fishing line stop of claim 1, wherein said knot further comprises a rubber band.

10. A method of transferring a knot onto and encircling a main body of a fishing line stop; said main body having a opening therethrough for the passage of a fishing line; the said knot attached and releasable from said main body and onto said fishing line.
